(19) United States
(12) Patent Application Publication
(10) Pub. No.: US 2012/0106411 A1
(43) Pub. Date: May 3, 2012

(54) PORTABLE ROUTER

(75) Inventors: YU-MING TSENG, HSINCHU (TW); CHUN-MIN HUANG, HSINCHU (TW)

(73) Assignee: NETRONIX, INC., HSINCHU (TW)

(21) Appl. No.: 12/915,402

(22) Filed: Oct. 29, 2010

(51) Int. Cl. H04B 7/00; H04L 12/56

(52) U.S. Cl. 370/310; 370/401

(57) ABSTRACT

A portable router comprises a memory unit, a network sharing port, an operating/processing unit connecting with the two components. The memory unit has an original parameter configuration area and an updated parameter configuration area. An originally-configured network address and a prime DHCP server address range are built in the original parameter configuration area. The network sharing port has an external network connection port and an internal network connection port. The external network connection port implements connection with an external network having an external network address. The internal network connection port implements an internal network. The operating/processing unit retrieves the originally-configured network address and compares it with the external network address. When two addresses are identical, the operating/processing unit generates a new network address different from the external network address and a new DHCP server address range. When two addresses are different, the operating/processing unit directly adopts the originally-configured network address.

### BACKGROUND OF THE INVENTION

1. Field of the Invention

The present invention relates to a router, particularly to a router that can automatically allocate ranges of Internet addresses.

2. Description of the Related Art

With the population of mobile offices, many business travelers use the network system of the hotel to run their jobs. A business traveler may have several devices needing Internet access and respectively needing IP addresses, such as a notebook computer, an E-book, PDA, and a mobile phone. However, the current hotels normally provide a single network port and a single IP address for one room, which are usually insufficient for a business traveler. Therefore, a business traveler often counts on a portable router to provide a plurality of IP addresses for his devices.

Different manufacturers, or even an identical manufacturer, may assign an identical IP address to different portable routers they or it produces. For example, a portable router may have an assigned IP address identical to that of a portable router of one room in a hotel. In such a case, although the user of the room still can successfully obtain an IP address, the user cannot Internet access via the conflicting IP address. When IP addresses conflict, the current portable routers do not provide any error message. Such a problem should trouble the users very much.

Accordingly, the present invention proposes a portable router, which can automatically switch IP addresses, to overcome the above-mentioned problem.

### SUMMARY OF THE INVENTION

The primary objective of the present invention is to provide a portable router, which can automatically modify the allocated ranges of IP addresses to exclude the IP address range used by the external network server lest the IP addresses of the internal network and the external network conflict.

To achieve the abovementioned objectives, the present invention proposes a portable router, which comprises a memory unit, a network sharing port, an operating/processing unit connecting with the memory unit and the network sharing port.

The memory unit has an original parameter configuration area and an updated parameter configuration area. An originally-configured network address and a prime DHCP (Dynamic Host Configuration Protocol) server address range are built in the original parameter configuration area.

The network sharing port has an external network connection port and an internal network connection port. The external network connection port enables the portable router to connect with an external network having an external network address. The internal network connection port connects with at least one Internet-access device to form an internal network.

In operation, the operating/processing unit retrieves the originally-configured network address and compares the originally-configured network address with the external network address. When the two addresses are identical, the operating/processing unit generates a new network address different from the external network address and a new DHCP server address range, and stores the new network address and new DHCP server address range in the updated parameter configuration area for application of the internal network. When the two addresses are different, the operating/processing unit directly adopts the originally-configured network address to configure the internal network address.

Below, the embodiments are described in detail in cooperation with the drawings to make easily understood the technical contents and accomplishments of the present invention.

### BRIEF DESCRIPTION OF THE DRAWINGS

FIG. 1 is a block diagram schematically showing the architecture of a portable router according to a first embodiment of the present invention;

FIG. 2 is a block diagram schematically showing the architecture of a portable router according to a second embodiment of the present invention;

FIG. 3 is a flowchart of the operation of a portable router according to the first embodiment of the present invention; and

FIG. 4 is a flowchart of the operation of a portable router according to the second embodiment of the present invention.

### DETAILED DESCRIPTION OF THE INVENTION

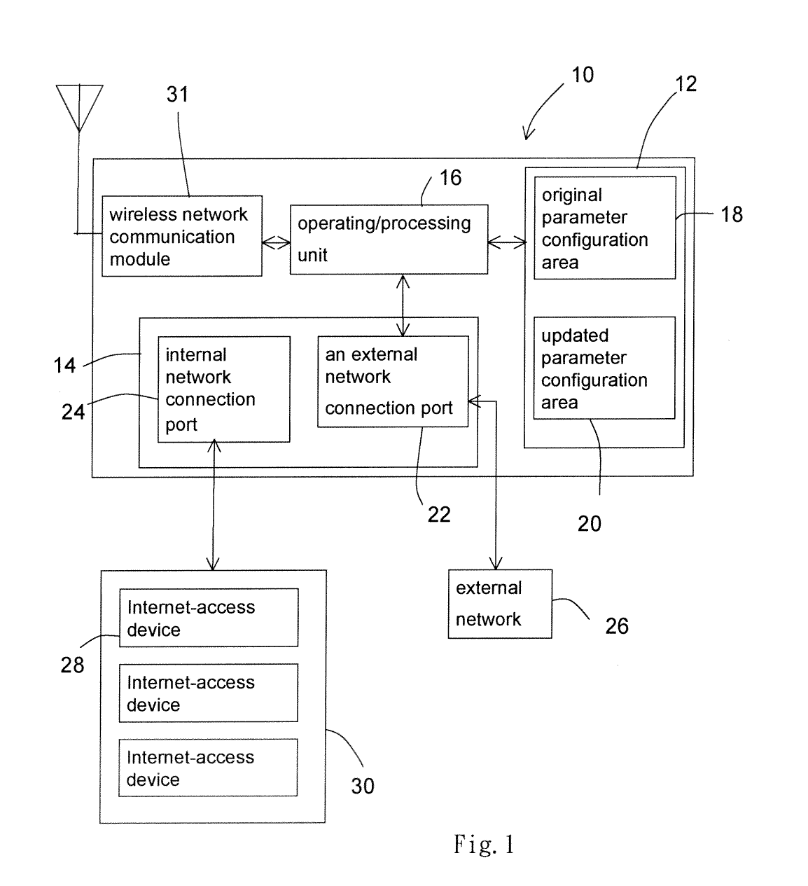

Refer to FIG. 1 a block diagram schematically showing the architecture of a portable router according to a first embodiment of the present invention. The portable router 10 of the present invention comprises a memory unit 12, a network sharing port 14, an operating/processing unit 16 connecting with the memory unit 12 and the network sharing port 14.

The memory unit 12 has an original parameter configuration area 18 and an updated parameter configuration area 20. An originally-configured network address and a prime DHCP (Dynamic Host Configuration Protocol) server address range are built in the original parameter configuration area 18.

The network sharing port 14 has an external network connection port 22 and an internal network connection port 24. The external network connection port 22 enables the portable router 10 to connect with an external network 26 having an external network address. The internal network connection port 24 connects with at least one Internet-access device 28 to form an internal network 30.

When the portable router 10 of the present invention undertakes configuration of the internal network address, the operating/processing unit 16 retrieves the originally-configured network address, and compares the originally-configured network address with the external network address. When the two addresses are identical, the operating/processing unit 16 generates a new network address different from the external network address and a new DHCP server address range, and stores the new network address and new DHCP server address range in the updated parameter configuration area 20 for application of the internal network 30. When the two addresses are different, the operating/processing unit 16 directly adopts the originally-configured network address to configure the internal network address.

The memory unit 12 may be a flash memory.

The portable router 10 of the present invention may further comprise a wireless network communication module 31, which receives wireless signals from the Internet access devices 28 and transmits the signals to the operating/processing unit 16, or converts the data of packets coming from the operating/processing unit 16 into wireless signals for application of the internal network 30.

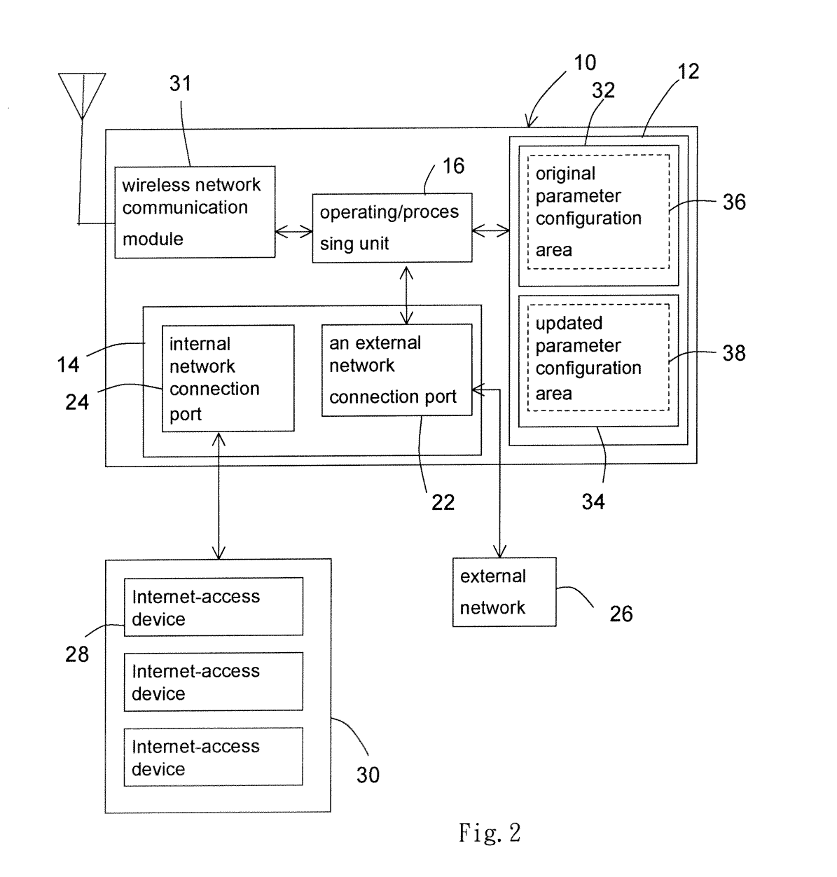

Refer to FIG. 2 a block diagram schematically showing the architecture of a portable router according to a second embodiment of the present invention. In this embodiment, the memory unit 12 includes a flash memory 32 and an SDRAM (Synchronous Dynamic Random Access Memory) 34; an original parameter configuration area 36 is arranged on the flash memory 32; an updated parameter configuration area 38 is arranged in the buffer area of the SDRAM 34.

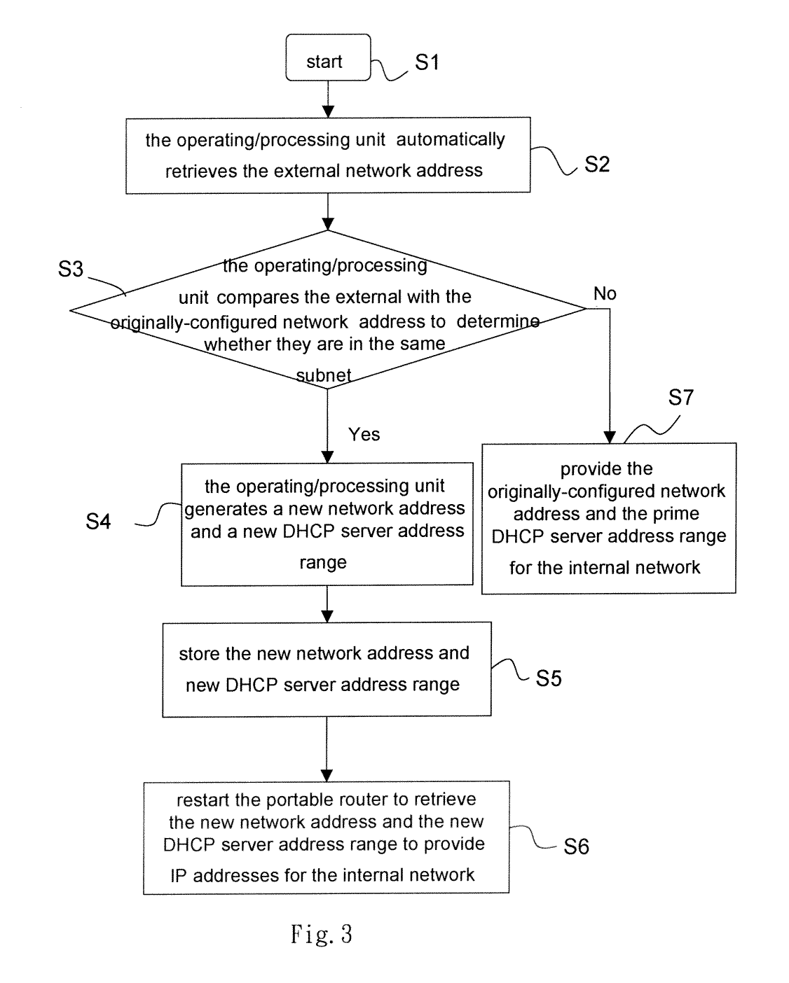

Refer to FIG. 1 and FIG. 3. FIG. 3 is a flowchart of the operation of a portable router according to the first embodiment of the present invention. In Step S1, start the portable router 10 of the present invention. In Step S2, the operating/processing unit 16 automatically retrieves the external network address. In Step S3, the operating/processing unit 16 compares the external network address with the originally-configured network address. If the external network address and the originally-configured network address are in the same subnet, the process proceeds to Step S4. In Step S4, the operating/processing unit 16 generates a new network address different from the originally-configured network address and a new DHCP server address range different from the prime DHCP server address range. Next, the process proceeds to Step S5. In Step S5, the operating/processing unit 16 stores the new network address and new DHCP server address range in the updated parameter configuration area 20. Next, the process proceeds to Step S6. In Step S6, restart the portable router 10 without interrupting power supply so as to retrieve the new network address as the internal network IP of the portable router 10 and retrieve the new DHCP server address range to provide IP addresses for the internal network 30 (i.e. assign IP addresses to the Internet-access devices 28 connecting with the portable router 10).

If the external network address and the originally-configured network address are determined to be in different subnets in Step S3, the process proceeds to Step S7. In Step S7, the operating/processing unit 16 provides the originally-configured network address and the prime DHCP server address range for the internal network 30.

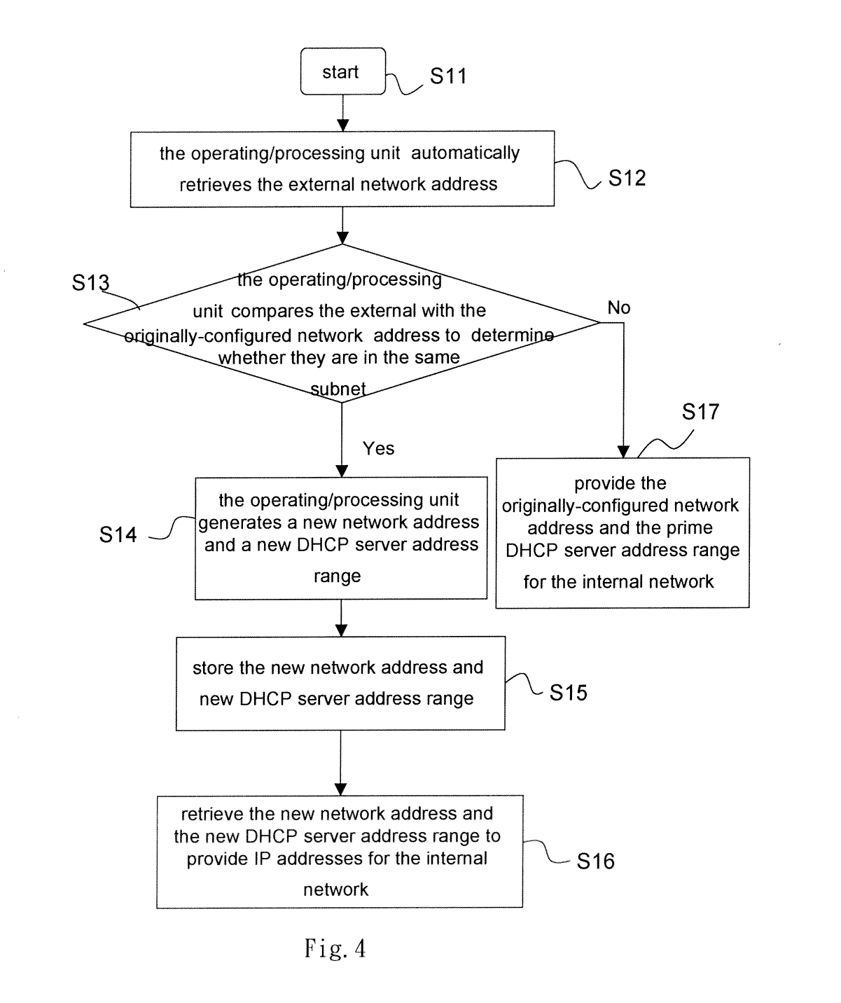

Refer to FIG. 2 and FIG. 4. FIG. 4 is a flowchart of the operation of a portable router according to the second embodiment of the present invention. In Step S11, start the portable router 10 of the present invention. In Step S12, the operating/processing unit 16 automatically retrieves the external network address. In Step S13, the operating/processing unit 16 compares the external network address with the originally-configured network address. If the external network address and the originally-configured network address are in the same subnet, the process proceeds to Step S14. In Step S14, the operating/processing unit generates a new network address different from the originally-configured network address and a new DHCP server address range different from the prime DHCP server address range. Next, the process proceeds to Step S15. In Step S15, the operating/processing unit 16 stores the new network address and new DHCP server address range in the updated parameter configuration area 38. Next, the process proceeds to Step S16. In Step S16, the operating/processing unit 16 retrieves the new network address and new DHCP server address range as new parameters of the portable router 10 for application of the internal network 30.

If the external network address and the originally-configured network address are determined to be in different subnets in Step S13, the process proceeds to Step S17. In Step S17, the operating/processing unit 16 provides the originally-configured network address and the prime DHCP server address range for the internal network 30.

In conclusion, the present invention proposes a novel portable router, which not only can automatically assign IP addresses to Internet-access devices connecting with the portable router but also can automatically modify the allocated ranges of IP addresses to exclude the IP address range used by the external network server lest the IP addresses of the internal network and the external network conflict.

The embodiments described above are only to exemplify the present invention but not to limit the scope of the present invention. Any equivalent modification or variation according to the spirit or characteristic of the present invention is to be also included within the scope of the present invention.

What is claimed is:

1. A portable router comprising
a memory unit including an original parameter configuration area and an updated parameter configuration area, wherein an originally-configured network address and a prime DHCP (Dynamic Host Configuration Protocol) server address range are built in said original parameter configuration area;
a network sharing port including an external network connection port and an internal network connection port, wherein said external network connection port enables said portable router to connect with an external network having an external network address, and wherein said internal network connection port connects with at least one Internet-access device to form an internal network; and
an operating/processing unit electrically connecting with said memory unit and said network sharing port, retrieving said originally-configured network address, comparing said originally-configured network address with said external network address, generating a new network address different from said external network address and a new DHCP server address range, and storing said new network address and said new DHCP server address range in said updated parameter configuration area for application of said internal network if said originally-configured network address and said external network address are in an identical subnet, and directly adopting said originally-configured network address if said originally-configured network address and said external network address are in different subnets.

2. The portable router according to claim 1, wherein said memory unit is a flash memory.

3. The portable router according to claim 1, wherein said memory unit includes a flash memory and an SDRAM (Synchronous Dynamic Random Access Memory), and wherein said original parameter configuration area is arranged on said flash memory, and wherein said updated parameter configuration area is arranged in a buffer area of said SDRAM.

4. The portable router according to claim 1 further comprising a wireless network communication module converting data of packets coming from said operating/processing unit into wireless signals.
